(19) United States
(12) Patent Application Publication
(10) Pub. No.: US 2025/0150419 A1
(43) Pub. Date: May 8, 2025

(54) CONTROL DEVICE, DETECTION SYSTEM, CONTROL METHOD, AND RECORDING MEDIUM

(71) Applicant: NEC Corporation, Tokyo (JP)

(72) Inventors: Shota Kizukuri, Tokyo (JP); Takahisa Yutoku, Tokyo (JP); Wataru Takahashi, Tokyo (JP); Yusuke Matsui, Tokyo (JP); Yoshihiko Koizumi, Tokyo (JP); Shota Umeki, Tokyo (JP)

(73) Assignee: NEC Corporation, Tokyo (JP)

(21) Appl. No.: 18/825,511

(22) Filed: Sep. 5, 2024

(30) Foreign Application Priority Data
Nov. 7, 2023 (JP) 2023-189735

(51) Int. Cl. H04L 51/212; G06F 3/147; H04L 9/40

(52) U.S. Cl. CPC H04L 51/212; G06F 3/147; H04L 63/1483

(57) ABSTRACT

Provided is a control device which includes a display information generation unit that generates display information in which a plurality of pieces of information regarding an electronic mail that has been transmitted to a management target company and is likely to be a fraudulent e-mail are displayed side by side, and a display control unit that performs control to display the generated display information on a screen.

This application is based upon and claims the benefit of priority from Japanese Patent Application No. 2023-189735, filed on Nov. 7, 2023, the disclosure of which is incorporated herein in its entirety by reference.

### TECHNICAL FIELD

The present disclosure relates to a control device, a detection system, a control method, and a recording medium.

### BACKGROUND ART

Business E-mail Compromise (BEC) is a fraud that sends an electronic mail (fraudulent e-mail) including the content of the fraud to an employee of a target company and deceives the employee of the target company. A scheme of impersonating an executive of a target company and transmitting malicious fraudulent e-mails to employees has a high risk of spread of damage. Therefore, it is required to accurately detect a fraudulent e-mail.

PTL 1 (JP 2021-009464 A) discloses an information processing device that identifies a sender of an electronic mail. When an electronic mail is received from an external e-mail server, the device of PTL 1 extracts an e-mail address of a transmission source, an e-mail address of an e-mail address, an internet protocol (IP) address of an e-mail server, route information of an e-mail server, and the like based on settings. The device of PTL 1 determines a color to be assigned or the like from a value obtained by inputting information extracted from an e-mail to a hash function. The device of PTL 1 displays an e-mail address or the like with a determined color or the like attached thereto.

In the method of PTL 1, when an electronic mail arrives at a client terminal, a color of an e-mail address or the like is changed according to a change in a transmission source address of a sender. According to the method of PTL 1, it is possible to detect a fraudulent e-mail that can be used in business e-mail fraud when an electronic mail arrives at a client terminal. In the method of PTL 1, even if a fraudulent e-mail received by a client terminal used by an employee of a company can be detected, it is difficult to ensure computer security related to the company.

An object of the present disclosure is to provide a control device, a detection system, a control method, and a program capable of grasping computer security such as a fraudulent e-mail.

### SUMMARY

A control device according to an aspect of the present disclosure includes a display information generation unit that generates display information in which a plurality of pieces of information regarding an electronic mail that has been transmitted to a management target company and is likely to be a fraudulent e-mail are displayed side by side, and a display control unit that performs control to display the generated display information on a screen.

In a display control method according to an aspect of the present disclosure, the method includes generating display information in which a plurality of pieces of information regarding an electronic mail that has been sent to a management target company and is likely to be a fraudulent e-mail are displayed side by side, and performing control to display the generated display information on a screen.

A program according to an aspect of the present disclosure causes a computer to execute processing of generating display information in which a plurality of pieces of information related to an electronic mail that has been transmitted to a management target company and is likely to be a fraudulent e-mail is displayed side by side, and processing of controlling to display the generated display information on a screen.

### BRIEF DESCRIPTION OF THE DRAWINGS

Exemplary features and advantages of the present invention will become apparent from the following detailed description when taken with the accompanying drawings in which:

FIG. 1 is a conceptual diagram for explaining an example of a configuration of a detection system according to the present disclosure;

FIG. 2 is a conceptual diagram for explaining an example of a typical pattern of business e-mail fraud;

FIG. 3 is a conceptual diagram illustrating an example of authorization/non-authorization determination of an electronic mail in the detection system according to the present disclosure;

FIG. 4 is a conceptual diagram illustrating an example of authorization/non-authorization determination of an electronic mail in the detection system according to the present disclosure;

FIG. 5 is a conceptual diagram illustrating an example of a configuration of a detection device included in the detection system according to the present disclosure;

FIG. 6 is a table illustrating an example of a whitelist used by the detection device included in the detection system according to the present disclosure;

FIG. 7 is a table illustrating an example of a blacklist used by the detection device included in the detection system according to the present disclosure;

FIG. 8 is a conceptual diagram illustrating an example of a configuration of a control device included in the detection system according to the present disclosure;

FIG. 9 is a conceptual diagram illustrating an example of display information generated by the control device included in the detection system according to the present disclosure;

FIG. 10 is a conceptual diagram illustrating an example of display information generated by the control device included in the detection system according to the present disclosure;

FIG. 11 is a conceptual diagram illustrating an example of display information generated by the control device included in the detection system according to the present disclosure;

FIG. 12 is a flowchart for explaining an example of the operation of the detection device included in the detection system according to the present disclosure;

FIG. 13 is a flowchart for explaining an example of fraudulent e-mail detection processing by the detection device included in the detection system according to the present disclosure;

FIG. 14 is a flowchart for explaining an example of the operation of the control device included in the detection system according to the present disclosure;

FIG. 15 is a block diagram illustrating an example of a configuration of a control device according to the present disclosure;

FIG. 16 is a flowchart for explaining an example of the operation of the control device according to the present disclosure; and

FIG. 17 is a block diagram illustrating an example of a hardware configuration that executes control and processing according to the present disclosure.

### EXAMPLE EMBODIMENT

Example embodiments of the present invention will be described below with reference to the drawings. In the following example embodiments, technically preferable limitations are imposed to carry out the present invention, but the scope of this invention is not limited to the following description. In all drawings used to describe the following example embodiments, the same reference numerals denote similar parts unless otherwise specified. In addition, in the following example embodiments, a repetitive description of similar configurations or arrangements and operations may be omitted.

### First Example Embodiment

First, a configuration of a detection system according to a first example embodiment will be described with reference to the drawings. The detection system according to the present example embodiment detects an unauthorized electronic mail (unauthorized e-mail) transmitted by impersonating an authorized sender from among the electronic mails transmitted to a management target company. For example, an unauthorized e-mail may include a fraudulent e-mail intended to deceive employees of the management target company. The detection system according to the present example embodiment displays display information enabling accurate recognition of information regarding the detected unauthorized e-mail on a screen of a management terminal used by an administrator or the like. Hereinafter, for convenience of description, it is assumed that the unauthorized e-mail is an electronic mail that may be a fraudulent e-mail.

Hereinafter, an example of detecting a fraudulent e-mail impersonated as a manager of a company will be described. For example, a fraudulent e-mail used for business e-mail fraud is difficult to detect because there is no uniform resource locator (URL) or malware attachment. In the present example embodiment, a fraudulent e-mail is detected by using header information of an electronic mail. The method according to the present example embodiment can be applied not only to detection of a fraudulent e-mail impersonated as a manager of a company but also to detection of a fraudulent e-mail impersonated as an arbitrary person.

### (Configuration)

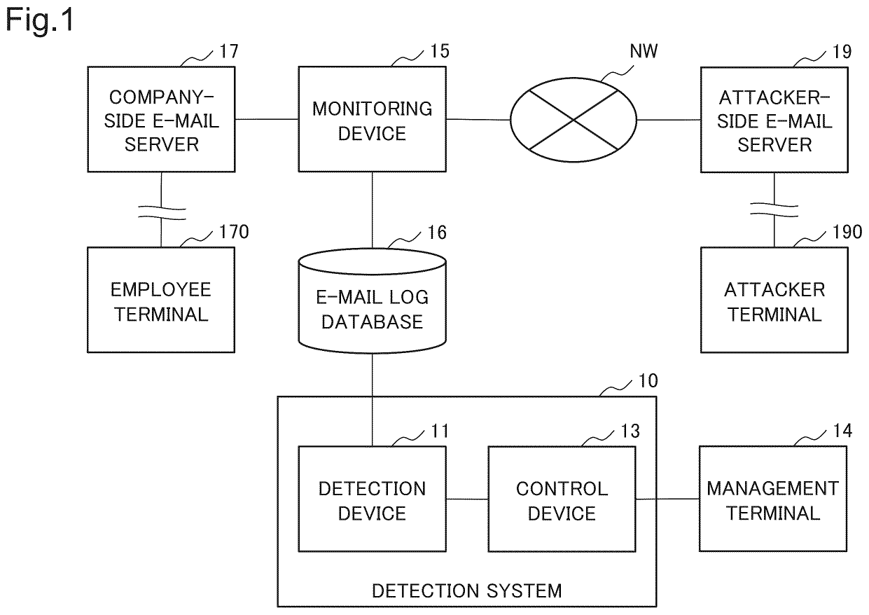

FIG. 1 is a block diagram for explaining an example of a configuration of a detection system according to the present disclosure. A detection system 10 includes a detection device 11 and a control device 13. FIG. 1 illustrates a management terminal 14, a monitoring device 15, an e-mail log database 16, a company-side e-mail server 17, and an attacker-side e-mail server 19. FIG. 1 illustrates an employee terminal 170 and an attacker terminal 190. FIG. 1 illustrates a configuration according to the present disclosure among configurations of a system, a device, and the like used for transmission and reception of electronic mails.

The monitoring device 15 is connected to a network NW such as the Internet. The monitoring device 15 is connected to the e-mail log database 16 and the company-side e-mail server 17. The monitoring device 15 may not be disposed between the network NW and the company-side e-mail server 17, and may monitor the company-side e-mail server 17 connected to the network NW in a cloud. The monitoring device 15 may be configured as hardware or software.

The monitoring device 15 monitors electronic mails transmitted and received via the company-side e-mail server 17. The monitoring device 15 monitors the header information of the electronic mail transmitted to the company-side e-mail server 17. For example, the header information of the electronic mail includes a transmission source address, a sender display name, a transmission destination address, a subject, and a transmission date and time. For example, the header information of the electronic mail includes a route through which the electronic mail is delivered, a reply destination of the electronic mail, and a return destination when an error occurs in the delivery of the electronic mail. For example, the header information of the electronic mail includes an identification number of the electronic mail, information regarding software of the electronic mail used by a transmission source, and an authentication result of a transmission e-mail address. The information included in the header information of the electronic mail is not limited to the above example.

The monitoring device 15 detects header information including information having features of a fraudulent e-mail. For example, the monitoring device 15 detects information having the feature of the fraudulent e-mail from the sender display name and the subject. Examples of the sender display name of the detection target include names of a manager, an administrator, and an employee of the management target company. In particular, fraudulent e-mails that deceive an executive level (C-Suite) of a management target company may cause employees to blindly follow instructions. Therefore, it is required to accurately detect a fraudulent e-mail that deceives the executive level. There may be a situation in which the employee does not recognize the names of the affiliated company and the representative in the case of the fraudulent e-mail deceiving the representative of the domestic affiliated company and the representative of the overseas affiliated company. Therefore, it is required to accurately detect a fraudulent e-mail that deceives a representative of the domestic affiliated company or a representative of the overseas affiliated company. Examples of the detection target subject include merger, acquisition, Brief call, Urgent Request, and the like. There is a possibility that a large amount of money is transferred to the transmission source for a fraudulent e-mail including textual information such as merger or acquisition in the subject. Therefore, it is required to accurately detect a fraudulent e-mail including textual information such as merger or acquisition in the subject. There is a possibility of responding in a hurry to a fraudulent e-mail including information such as Urgent Request in the subject. Therefore, it is required to accurately detect a fraudulent e-mail including information such as Urgent Request in the subject.

The monitoring device 15 may monitor the header information of an electronic mail transmitted from the company-side e-mail server 17. With such a configuration, the monitoring device 15 can monitor an electronic mail transmitted from the employee terminal 170. For example, it is possible to prevent remittance of money to a fraudulent e-mail in advance according to a feature expression included in the header information of an electronic mail transmitted from the employee terminal 170. For example, according to a feature expression included in the header information of an electronic mail transmitted from the employee terminal 170, it is possible to detect an event in which money has been remitted to an attacker who is a transmission source of a fraudulent e-mail. For example, it is possible to detect the employee terminal 170 that has transmitted the electronic mail including the violation of the business regulations according to the feature expression included in the header information of the electronic mail transmitted from the employee terminal 170.

The monitoring device 15 stores the header information of the detection target e-mail in the e-mail log database 16. For example, the detection target e-mail is an electronic mail (also referred to as an unauthorized e-mail) that may be a fraudulent e-mail. In a case where the electronic mail that may be a fraudulent e-mail is the detection target e-mail, the determination target of whether the electronic mail is a fraudulent e-mail can be narrowed down. For example, the detection target e-mail may be all the electronic mails transmitted to the company-side e-mail server 17. In a case where all the electronic mails transmitted to the company-side e-mail server 17 are detection target e-mails, it is possible to reduce fraudulent e-mail omission. The monitoring device 15 may store the body of the detection target e-mail in the e-mail log database 16. The monitoring device 15 may store an attached file of the detection target e-mail in the e-mail log database 16. The body of the detection target e-mail, the file name of the attached file of the detection target e-mail, and the attached file of the detection target e-mail can also be the detection target for a fraudulent e-mail.

The company-side e-mail server 17 is an e-mail server through which an electronic mail transmitted and received via a terminal device used in the management target company passes. Normally, the company-side e-mail server 17 is connected to a plurality of employee terminals 170. The company-side e-mail server 17 is connected to the network NW via the monitoring device 15. The company-side e-mail server 17 may be connected to the network NW without passing through the monitoring device 15. The electronic mails transmitted to the company-side e-mail server 17 are distributed to the employee terminal 170 designated by the transmission destination address included in the header information of the electronic mails. The electronic mails transmitted from the company-side e-mail server 17 are distributed toward the transmission destination designated by the transmission destination address included in the header information of the electronic mails.

The attacker-side e-mail server 19 is an e-mail server connected to the attacker terminal 190. The attacker-side e-mail server 19 is one of servers connected to the network NW. The attacker terminal 190 is a terminal device used by an attacker who performs fraud by using a fraudulent e-mail. The attacker terminal 190 transmits a fraudulent e-mail in response to an operation by the attacker. The fraudulent e-mail is transmitted toward the transmission destination address via the attacker-side e-mail server 19 and the network. The fraudulent e-mail transmitted toward the transmission destination address of the management target company is monitored by the monitoring device 15 and reaches the company-side e-mail server 17. The fraudulent e-mail that has reached the company-side e-mail server 17 is distributed to the employee terminal 170 that is the transmission destination of the fraudulent e-mail.

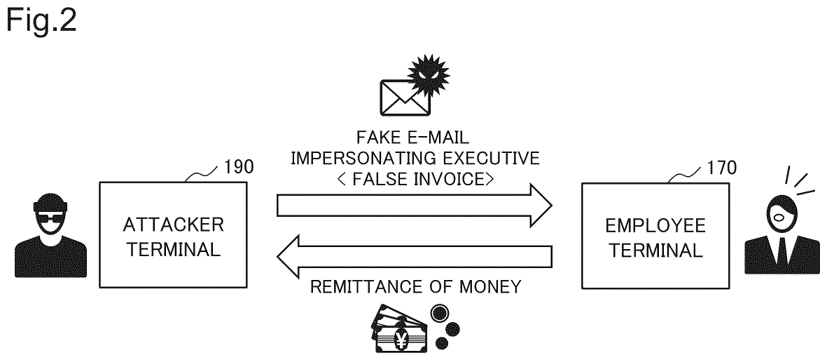

FIG. 2 is a conceptual diagram for explaining an example of a typical pattern of business E-mail compromise (BEC). The attacker transmits, toward an employee of the company to which the executive belongs, a fraudulent e-mail that deceives the executive in the sender display name by using the attacker terminal 190. In the example of FIG. 2, it is assumed that a fraudulent e-mail is attached with a false invoice instructing remittance of money to an attacker impersonating an executive. When the employee using the employee terminal 170 at the transmission destination of the fraudulent e-mail browses the fraudulent e-mail, the employee verifies the content of the fraudulent e-mail. In a case where the sender display name of the sent fraudulent e-mail is an executive, the employee may blindly follow the instructions in the fraudulent e-mail. In the example of FIG. 2, the employee has remitted money to the account designated by the attacker in response to the instruction of the fraudulent e-mail. In order to prevent the occurrence of the case as illustrated in FIG. 2, the detection system 10 according to the present example embodiment detects a fraudulent e-mail by using header information of an electronic mail, and displays display information regarding the detected fraudulent e-mail on a screen of the management terminal 14. The display information regarding the fraudulent e-mail may be displayed on the screen of the employee terminal 170.

The detection device 11 is connected to the e-mail log database 16. The detection device 11 uses an e-mail log stored in the e-mail log database 16 to detect a detection target e-mail including a fraudulent e-mail from among the electronic mails transmitted to the employees of the management target company. The detection device 11 detects the detection target e-mail using the header information of the e-mail log stored in the e-mail log database 16. Specifically, the detection device 11 compares the e-mail address of the sender included in the header information of the e-mail log with the authorized transmission source address of the sender. For example, the detection device 11 detects an electronic mail in which the authorized transmission source address of the sender included in the header information of the e-mail log and the e-mail address of the sender included in the header information are different as the detection target e-mail. For example, the detection device 11 detects a detection target e-mail (fraudulent e-mail) with reference to a whitelist which is a list of authorized e-mail addresses. For example, a detection unit 113 detects an electronic mail that is not included in the whitelist as a detection target e-mail (fraudulent e-mail).

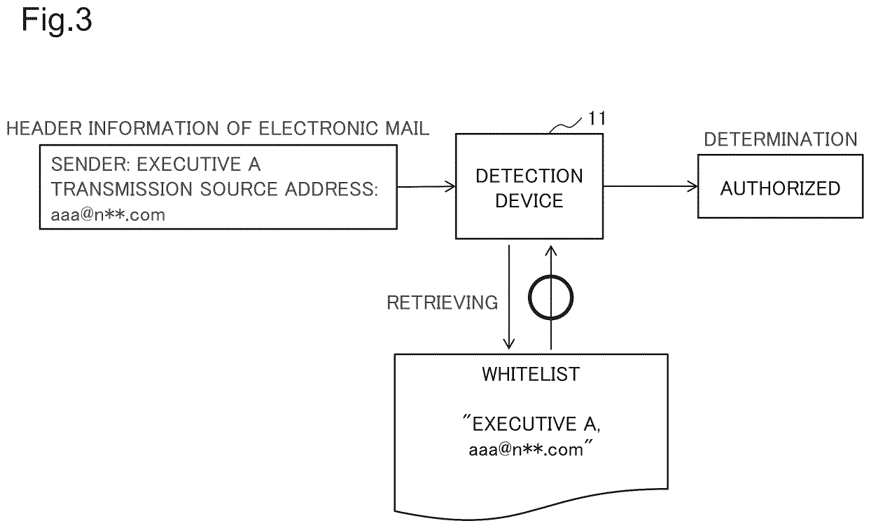

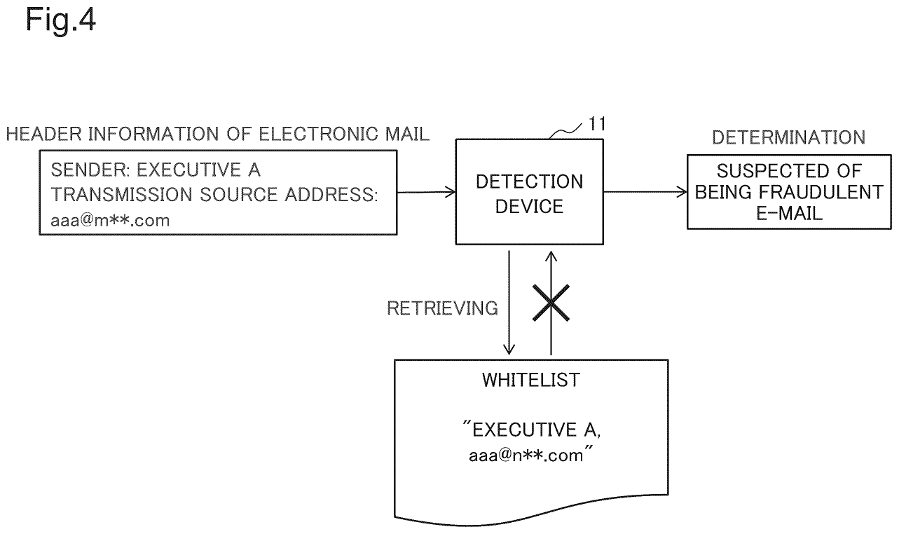

FIGS. 3 to 4 are conceptual diagrams for explaining a detection example of a fraudulent e-mail using a whitelist. FIG. 3 illustrates a detection example of an electronic mail (authorized e-mail) transmitted from an authorized executive A belonging to the management target company. FIG. 4 illustrates a detection example of an electronic mail (fraudulent e-mail) transmitted from an attacker impersonating the executive A belonging to the management target company.

In the example of FIG. 3, the header information of the received electronic mail includes information indicating that the sender is “executive A” and the transmission source address is “aaa@n**.com”. The detection device 11 refers to the whitelist and retrieves the “executive A” displayed as the sender of the electronic mail. In the whitelist, an authorized address “aaa@n**.com” of the “executive A” is registered. The detection device 11 compares the transmission source address included in the header information of the received electronic mail with the authorized address retrieved from the whitelist regarding the “executive A”. In the example of FIG. 3, the transmission source address included in the header information of the received electronic mail matches the authorized address retrieved from the whitelist. Therefore, the detection device 11 determines that the received electronic mail is an electronic mail transmitted from the authorized address.

In the example of FIG. 4, the header information of the received electronic mail includes information indicating that the sender is an “executive A” and the transmission source address is “aaa@m**.com”. The detection device 11 refers to the whitelist and retrieves the “executive A” displayed as the sender of the electronic mail. In the whitelist, an authorized address “aaa@n**.com” of the “executive A” is registered. The detection device 11 compares the transmission source address included in the header information of the received electronic mail with the authorized address retrieved from the whitelist regarding the “executive A”. In the example of FIG. 4, the domain name of the transmission source address included in the header information of the received electronic mail does not match the domain name of the authorized address retrieved from the whitelist. Therefore, the detection device 11 determines that the received electronic mail is suspected of being a fraudulent e-mail.

The detection device 11 retrieves the e-mail log stored in the e-mail log database 16 at a timing set in advance by the administrator. The detection device 11 detects the fraudulent e-mail using the retrieved e-mail log at a timing set in advance by the administrator. The detection timing of the fraudulent e-mail is set by the administrator. For example, the detection timing of the fraudulent e-mail is set to a preset specific time. For example, the specific time is set to midnight or early morning when the communication volume is small. In a time zone with a small communication volume, an influence on transmission and reception of an electronic mail is less likely to occur. For example, the specific time may be set during the day when the communication volume is large. In a time zone with a large communication volume, a fraudulent e-mail can be detected in real time.

For example, the detection device 11 refers to the whitelist and verifies whether the electronic mail of the e-mail log recorded in the e-mail log database 16 is a fraudulent e-mail. In the whitelist, authorized e-mail addresses of executives, managers, and employees of the management target company are recorded.

The detection device 11 refers to the whitelist and retrieves the e-mail address of the sender included in the header information of the e-mail log. The detection device 11 compares the retrieved e-mail address of the sender with the transmission source address included in the header information of the e-mail log. In a case where the retrieved e-mail address of the sender does not match the transmission source address included in the header information, the detection device 11 detects the electronic mail of the e-mail log as a fraudulent e-mail. The detection device 11 outputs detection information indicating that the fraudulent e-mail is detected to the control device 13. The detection information includes the header information of the detected fraudulent e-mail. On the other hand, in a case where the retrieved e-mail address of the sender matches the transmission source address included in the header information, the detection device 11 detects the electronic mail of the e-mail log as an authorized e-mail. For example, the detection device 11 outputs a detection result indicating that the electronic mail of the e-mail log is an authorized e-mail. In this case, the detection device 11 may be configured not to perform specific processing.

The detection information includes information regarding a detection status of the fraudulent e-mail. For example, the information regarding the detection status of the fraudulent e-mail includes the number of times of detection of the fraudulent e-mail. For example, the number of times of detection of the fraudulent e-mail includes the number of fraudulent e-mails detected within the last week, within the last month, and within the last year. For example, the number of fraudulent e-mails detected within the last week, the number of fraudulent e-mails detected within the last month, and the number of fraudulent e-mails detected within the last year are displayed side by side. For example, a plurality of pieces of information regarding the detection status of the fraudulent e-mail are displayed adjacent to each other. For example, a plurality of pieces of information regarding the detection status of the fraudulent e-mail may be displayed on the screen of the management terminal 14 in a format aggregated on one screen. A format in which a plurality of pieces of information are displayed side by side is also referred to as a dashboard format. If a plurality of pieces of information regarding the detection status of the fraudulent e-mail is displayed on the screen in a dashboard format, it is possible to intuitively grasp the transition of the detection status of the fraudulent e-mail.

The information regarding the detection status of the fraudulent e-mail includes detection information for each electronic mail that may be a fraudulent e-mail. For example, the detection information for each electronic mail includes a detection date and time, a sender display name, a transmission destination address, a subject, the number of recipients, and the like. The detection date and time indicates the date and time when the monitoring device 15 has detected an electronic mail that may be a fraudulent e-mail. If the detection date and time, the sender display name, the transmission destination address, the subject, and the number of recipients are displayed on the screen in a dashboard format, it is possible to intuitively grasp each individual electronic mail that may be a fraudulent e-mail. For example, if the transition of the number of times of detection of the fraudulent e-mail and the detection information for each possible electronic mail are displayed on the screen in a dashboard format, it is possible to intuitively grasp the detection status of the fraudulent e-mails. For example, the transition of the number of times of detection of the fraudulent e-mail is expressed in a format in which numerical values of the number of times of detection in a plurality of predetermined periods having different temporal lengths are arranged in order of temporal lengths, such as the latest one week, one month, and one year. For example, in the transition of the number of times of detection of the fraudulent e-mail, the transition of the number of times of detection in a plurality of predetermined periods having different temporal lengths may be expressed in a graph form.

The management terminal 14 is a terminal device used by an administrator who manages the operation of the electronic mail of the management target company. The administrator manages the electronic mail of the management target company using the management terminal 14. For example, the administrator is an employee of the management target company. The administrator is not limited to an employee of the management target company. For example, the administrator may be a contractor who is entrusted with management of electronic mails of the management target company. The management terminal 14 is connected to the control device 13. For example, it may be configured such that an administrator can input information regarding a fraudulent e-mail to the control device 13 using the management terminal 14.

The control device 13 is connected to the management terminal 14. The control device 13 acquires the detection information generated by the detection device 11. The control device 13 generates display information including a detection status of a fraudulent e-mail by using the acquired detection information. The control device 13 displays the generated display information on the screen of the management terminal 14. The administrator who has browsed the display information displayed on the screen of the management terminal 14 can accurately grasp the detection status of the fraudulent e-mail. That is, the administrator can grasp computer security such as a fraudulent e-mail by browsing the display information displayed on the screen of the management terminal 14. For example, the display information regarding the fraudulent e-mail may be displayed on the screen of the employee terminal 170. The employee can pay attention to a fraudulent e-mail by viewing the display information displayed on the screen of the employee terminal 170. For example, the control device 13 may output the generated display information to an external system. The use of the display information output to the external system is not particularly limited. For example, it is possible to remotely check the detection status of the fraudulent e-mail by using the display information output to the external system.

### [Detection Device]

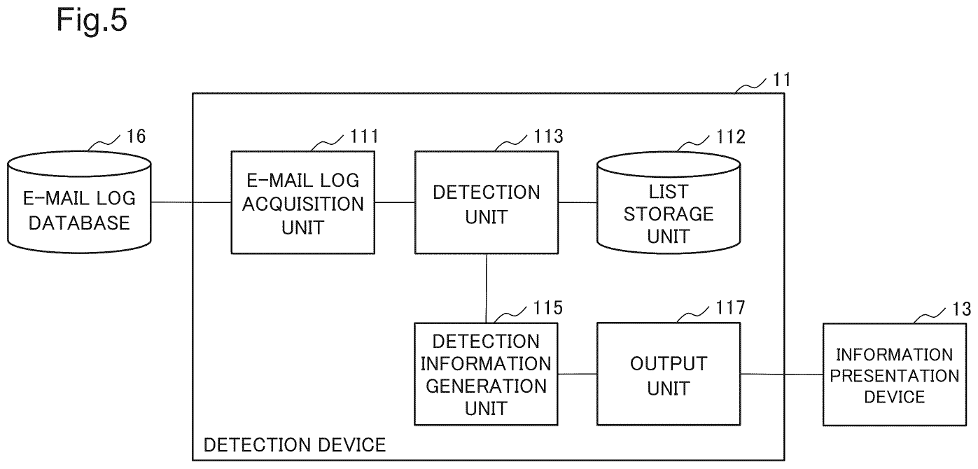

Next, the detection device 11 included in the detection system 10 of the present example embodiment will be described with reference to the drawings. FIG. 5 is a block diagram illustrating an example of a configuration of a detection device according to the present disclosure. The detection device 11 includes an e-mail log acquisition unit 111, a list storage unit 112, a detection unit 113, a detection information generation unit 115, and an output unit 117.

The e-mail log acquisition unit 111 is connected to the e-mail log database 16. The e-mail log acquisition unit 111 acquires the e-mail log accumulated in the e-mail log database 16. The e-mail log includes header information for each e-mail. The header information included in the e-mail log is used to detect a fraudulent e-mail.

The list storage unit 112 stores a whitelist in which authorized addresses of electronic mails used by employees such as executives, managers, and employees of the management target company are registered in association with the names of the employees. The electronic mail of the authorized address registered in the whitelist is a target detected as an authorized e-mail. The whitelist includes e-mail addresses of company electronic mails used by employees such as executives, managers, and employees of the management target company. The whitelist may include personal e-mail addresses of employees, such as executives, managers, and employees of the management target company. On the other hand, an electronic mail of an e-mail address not registered in the whitelist is a target to be detected as a fraudulent e-mail.

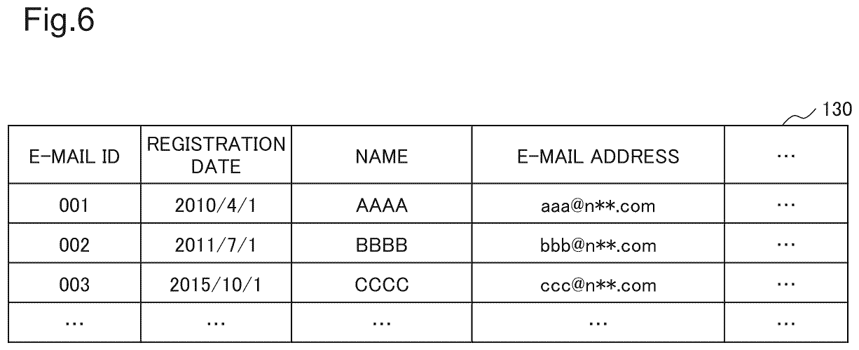

FIG. 6 is a table illustrating an example of the whitelist. In a whitelist 130, header information including information such as a registration date, a name, and an e-mail address is registered for each authorized e-mail identifier (ID). The whitelist 130 may include information other than an e-mail ID, a registration date, a name, and an e-mail address. The information registered in the whitelist 130 is updated according to an operation using the management terminal 14.

For example, a blacklist may be stored in the list storage unit 112. An e-mail address registered in the blacklist is a target to be detected as an unauthorized electronic mail. For example, the unauthorized electronic mail includes a fraudulent e-mail. For example, the unauthorized electronic mail includes an electronic mail including fake information. Hereinafter, for convenience of description, processing of the detection device 11 will be described on the assumption that the unauthorized electronic mail is an electronic mail that may be a fraudulent e-mail. An e-mail address not registered in the blacklist is an authorized address if registered in the whitelist. For example, in response to detecting an electronic mail that may be a new fraudulent e-mail, the header information of the electronic mail may be added to the blacklist.

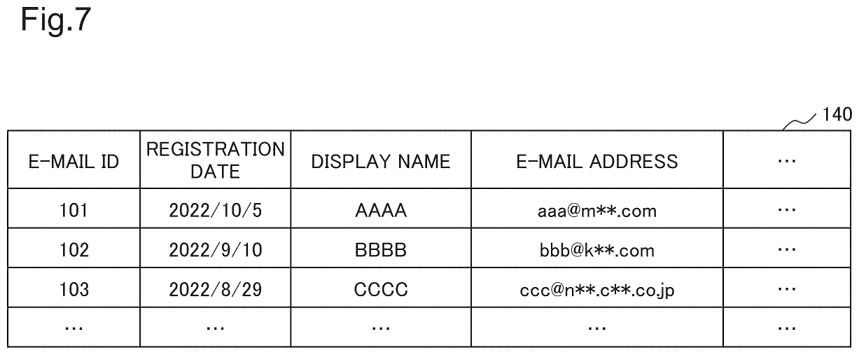

FIG. 7 is a table illustrating an example of the blacklist. In a blacklist 140, header information including information such as a registration date, a display name, and an e-mail address is registered for each e-mail ID of an electronic mail that may be a fraudulent e-mail. The blacklist 140 may include information other than an e-mail ID, a registration date, a name, and an e-mail address. For example, the blacklist 140 includes an e-mail address having the same account name as the authorized address but a different domain name. For example, the blacklist 140 may include an e-mail address having the same domain name as the authorized address but a different account name (user name). For example, the blacklist 140 may include e-mail addresses with different account names and domain names. For example, the blacklist 140 may also include an e-mail address having an account name or a domain name that is completely unrelated to the authorized e-mail address of the sender. The information registered in the blacklist 140 may be updated according to an operation using the management terminal 14.

The detection unit 113 extracts the sender and the transmission source address from the header information of the e-mail log. The detection unit 113 refers to the whitelist stored in the list storage unit 112 and retrieves the authorized address of the sender extracted from the header information of the e-mail log. The detection unit 113 detects an electronic mail that is not included in the whitelist as an unauthorized e-mail. For example, the detection unit 113 compares the transmission source address extracted from the header information of the e-mail log with the retrieved authorized address of the sender. In a case where the transmission source address extracted from the header information of the e-mail log does not match the retrieved authorized address of the sender, the detection unit 113 detects the electronic mail of the e-mail log as an electronic mail that may be a fraudulent e-mail. On the other hand, in a case where the transmission source address extracted from the header information of the e-mail log matches the retrieved authorized address of the sender, the detection unit 113 determines that the e-mail address is the authorized address. In this case, the detection unit 113 may output the determination result, or may not execute processing in particular.

The detection unit 113 may retrieve a fraudulent e-mail with reference to a blacklist stored in the list storage unit 112. The detection unit 113 detects the electronic mail included in the blacklist as an unauthorized e-mail. For example, the detection unit 113 compares the transmission source address extracted from the header information of the e-mail log with the e-mail address of the electronic mail retrieved from the blacklist. In a case where the transmission source address extracted from the header information of the e-mail log matches the e-mail address of the electronic mail retrieved from the blacklist, the detection unit 113 detects the electronic mail of the e-mail log as an electronic mail that may be a fraudulent e-mail. In this case, the detection unit 113 may output the determination result, or may not execute processing in particular. For example, the detection unit 113 may add header information of a newly detected fraudulent e-mail to the blacklist. When the header information of the new fraudulent e-mail is added to the blacklist, detection accuracy of the fraudulent e-mail using the blacklist is improved.

The detection unit 113 may detect the fraudulent e-mail with reference to the body or the attached file of the electronic mail. For example, the detection unit 113 detects an electronic mail in which a typical expression used in fraud is included in the body as an electronic mail that may be a fraudulent e-mail. For example, the detection unit 113 detects an electronic mail in which a typical expression used in fraud is included in the file name of the attached file as an electronic mail that may be a fraudulent e-mail.

The detection unit 113 may detect a fraudulent e-mail according to content of a plurality of electronic mails between the employee and the attacker. With such a configuration, there is a possibility that a fraudulent e-mail that cannot be detected by one electronic mail can be detected. For example, in the first electronic mail, a sender indication measures the employee's reaction to the fraudulent e-mail set as the executive. Then, a scheme of trusting an employee through a plurality of times of electronic mail exchange and deceiving the employee can be assumed. If a fraudulent e-mail is detected according to the content of a plurality of electronic mails, it is possible to detect even such a fraud scheme.

The detection information generation unit 115 generates detection information including the header information of an electronic mail that may be the detected fraudulent e-mail. For example, the detection information includes information such as a detection date and time, a sender display name, a transmission source address, a subject, and the number of recipients of an electronic mail that may be a fraudulent e-mail. The detection date and time is a date and time when information regarding an electronic mail that may be a fraudulent e-mail is detected. The detection date may be a date and time when information regarding an electronic mail that may be a fraudulent e-mail has been last detected (last detection date and time). The sender display name indicates a sender included in the header information of an electronic mail that may be a fraudulent e-mail. The transmission source address indicates an e-mail address at the transmission source included in the header information of an electronic mail that may be a fraudulent e-mail. The subject indicates a subject included in the header information of an electronic mail that may be a fraudulent e-mail. The number of recipients indicates the number of recipients of an electronic mail that may be a fraudulent e-mail in the management target company.

The output unit 117 is connected to the control device 13. The output unit 117 outputs the detection information regarding the fraudulent e-mail to the control device 13. The detection information output to the control device 13 is processed by the control device 13 into image information in a display format that makes it easy to accurately grasp the information regarding the fraudulent e-mail. The processed display information is displayed on the screen of the management terminal 14. The administrator who has browsed the display information displayed on the screen of the management terminal 14 can clearly grasp the information regarding the fraudulent e-mail. That is, the administrator who has browsed the display information displayed on the screen of the management terminal 14 can grasp computer security such as a fraudulent e-mail.

The administrator may be notified in response to detection of a fraudulent e-mail. For example, in response to the detection of a fraudulent e-mail, a notification in a format such as an electronic mail or an instant message is transmitted to the management terminal 14. The notification notifying the detection of a fraudulent e-mail may be displayed on the screen of the management terminal 14. The notification notifying of the detection of a fraudulent e-mail may be issued by voice from the speaker of the management terminal 14. For example, the notification indicating the detection of a fraudulent e-mail may be transmitted to a mobile terminal (not illustrated) carried by the administrator. The administrator who has received the notification in response to the detection of a fraudulent e-mail can recognize the detection of a fraudulent e-mail earlier than browsing the display information displayed on the screen of the management terminal 14.

The output unit 117 may transmit the detection information regarding a fraudulent e-mail to the monitoring device 15 or the company-side e-mail server 17. For example, the monitoring device 15 and the company-side e-mail server 17 block the electronic mail transmitted from the transmission source address included in the detection information of a fraudulent e-mail. For example, the monitoring device 15 and the company-side e-mail server 17 may transmit a warning e-mail to a transmission source address included in the detection information of the fraudulent e-mail. With such a configuration, it is possible to directly warn the transmission source of a fraudulent e-mail. For example, the monitoring device 15 and the company-side e-mail server 17 may report a transmission source address included in the detection information of a fraudulent e-mail to an organization such as a police department that manages the cyber security. With such a configuration, an organization such as a police department can respond to the transmission source of the fraudulent e-mail. For example, the monitoring device 15 and the company-side e-mail server 17 may transmit a transmission source address included in the detection information of a fraudulent e-mail to a news organization that announces information regarding the cyber security. With such a configuration, it is possible to raise attention to a fraudulent e-mail through the announcement regarding the fraudulent e-mail.

For example, the management terminal 14 may display information indicating the handling status of a fraudulent e-mail on the screen. If the handling of a fraudulent e-mail is in a stage before response, the status is expressed as before handling or unhandled. If the handling of a fraudulent e-mail is in process of handling, the status is expressed as being handled. If the handling of a fraudulent e-mail is completed, the status is expressed as handled. The status of the handling of a fraudulent e-mail is not limited to the above expression as long as the status of the handling of a fraudulent e-mail can be determined.

### [Control Device]

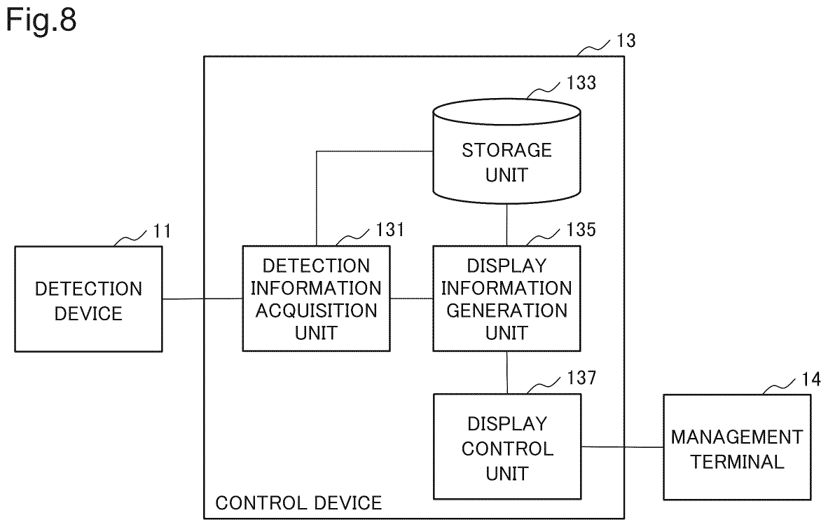

Next, the control device 13 included in the detection system 10 of the present example embodiment will be described with reference to the drawings. FIG. 8 is a block diagram illustrating an example of a configuration of a control device according to the present disclosure. The control device 13 includes a detection information acquisition unit 131, a storage unit 133, a display information generation unit 135, and a display control unit 137.

The detection information acquisition unit 131 is connected to the detection device 11. The detection information acquisition unit 131 acquires detection information from the detection device 11. The detection information includes header information of an electronic mail. The acquisition timing of the detection information is arbitrarily set. For example, the detection information acquisition unit 131 acquires the detection information from the detection device 11 at a predetermined acquisition timing. For example, the detection information acquisition unit 131 may acquire the detection information from the detection device 11 according to an operation of the management terminal 14 by the administrator.

The storage unit 133 stores a template of the display information displayed on the screen of the management terminal 14. The template of the display information is a template for displaying, in a dashboard format, the number of times of detection of the fraudulent e-mail, information regarding an electronic mail that may be a fraudulent e-mail, a report case of a fraudulent e-mail, and the like. In other words, the template of the display information is a format for displaying in a display format optimized for grasping the risk of a fraudulent e-mail. For example, the template of the display information includes a region in which a transition of the number of times of detection of the fraudulent e-mail is set. In the area, for example, the number of times of detection of the fraudulent e-mail in a predetermined period such as the latest one week, one month, or one year is displayed side by side. For example, the template of the display information includes a region in which information regarding each of the electronic mails that may be fraudulent e-mails is set. In the region, for example, information such as a detection date and time, a sender display name, a transmission source address, a subject, and the number of recipients is displayed side by side for each electronic mail that may be a fraudulent e-mail. For example, the template of the display information includes a region in which information regarding a report case of a fraudulent e-mail is set. In the region, for example, information such as a detected or reported date and time, a sender display name, a transmission source address, a subject, a screen dump of the fraudulent e-mail, and a feature is displayed side by side for each report case of the fraudulent e-mail. These regions may be set singly or in combination with other regions. For example, a region in which a transition of the number of times of detection of the fraudulent e-mail is set and a region in which information regarding individual electronic mails that may be fraudulent e-mails is set may be set to be displayed side by side.

The storage unit 133 stores detection information. The detection information of the detected fraudulent e-mail is accumulated in the storage unit 133. The detection information accumulated in the storage unit 133 is used to calculate a fraudulent e-mail detected in a predetermined period. For example, the predetermined period is a period such as the latest one week, one month, or one year. The detection information stored in the storage unit 133 may be erased according to an operation of the management terminal 14 by the administrator. For example, the detection information stored in the storage unit 133 may be automatically erased according to the elapse of a preset period.

The display information generation unit 135 acquires the detection information of the fraudulent e-mail from the detection information acquisition unit 131. The display information generation unit 135 acquires a template of the display information from the storage unit 133. The display information generation unit 135 generates display information in which information included in the detection information is arranged in a dashboard format. For example, the display information generation unit 135 generates display information in which a transition of the number of times of detection of the fraudulent e-mail is displayed. For example, the display information generation unit 135 generates display information in which the number of times of detection of the fraudulent e-mail in a predetermined period such as the latest one week, one month, or one year is displayed side by side. For example, the display information generation unit 135 generates display information in which information regarding each of electronic mails that may be fraudulent e-mails is displayed. For example, the display information generation unit 135 generates display information in which information such as a detection date and time, a sender display name, a transmission source address, a subject, and the number of recipients is displayed side by side for each electronic mail that may be a fraudulent e-mail. The number of recipients indicates the number of transmission destination addresses. In a case where a plurality of transmission destination addresses is included in one electronic mail, the number of transmission destination addresses is relevant to the number of recipients. For example, the display information generation unit 135 generates display information in which information regarding a report case of a fraudulent e-mail is displayed. For example, the display information generation unit 135 generates display information in which information such as a detected or reported date and time, a sender display name, a transmission source address, a subject, a screen dump (appearance), and a feature is displayed side by side for each report case of the fraudulent e-mail. These pieces of display information may be set singly, or may be set in combination with other regions. For example, a display region in which a transition of the number of times of detection of the fraudulent e-mail is displayed and display information in which information regarding individual electronic mails that may be fraudulent e-mails is displayed may be set to be displayed side by side. The display information generated by the display information generation unit 135 is not limited to the example described herein.

The display control unit 137 is connected to the management terminal 14. The display control unit 137 displays the display information generated by the display information generation unit 135 on the screen of the management terminal 14. The display control unit 137 displays, on the screen of the management terminal 14, display information in which a plurality of pieces of information regarding the fraudulent e-mail are displayed side by side. That is, on the screen of the management terminal 14, display information in which a plurality of pieces of information regarding the fraudulent e-mail is displayed in a dashboard format is displayed. The plurality of pieces of information regarding the fraudulent e-mail is displayed in a dashboard format so that the administrator can easily grasp the detection status of the fraudulent e-mail. That is, on the screen of the management terminal 14, information regarding the detection status of the fraudulent e-mail is displayed in association with each other in a display format optimized for grasping the risk of a fraudulent e-mail. For example, the display information may be output to an external system. In this case, the display control unit 137 outputs the display information to the external system via the network NW such as the Internet.

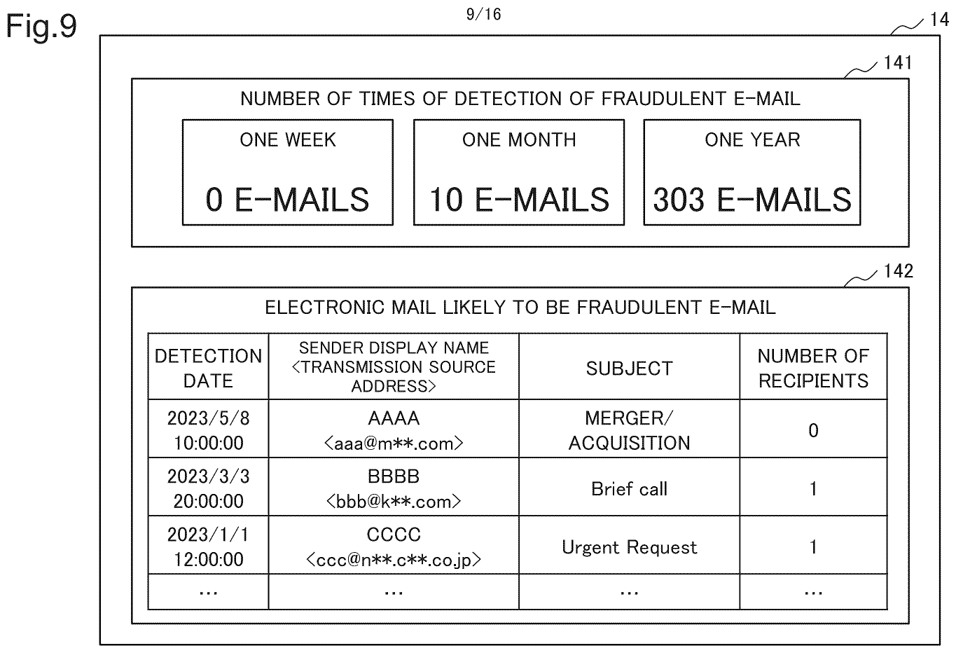

FIG. 9 is a conceptual diagram illustrating an example of display information displayed on the screen of the management terminal. In the example of FIG. 9, on the screen of the management terminal 14, display information 141 indicating the transition of the number of times of detection of the fraudulent e-mail and display information 142 including a list of electronic mails that may be fraudulent e-mails are displayed.

In the example of FIG. 9, on the screen of the management terminal 14, the display information 141 including the number of times of detection of the fraudulent e-mail in the latest one week, one month, and one year as a transition of the number of times of detection of the fraudulent e-mail. The display information including the transition of the number of times of detection of the fraudulent e-mail is referred to as first information. According to the display information 141, it is possible to accurately grasp that 0 fraudulent e-mails have been detected in the latest one week, 10 fraudulent e-mails have been detected in the latest one month, and 303 fraudulent e-mails have been detected in the latest one year. According to the display information 141, it is possible to intuitively grasp the transition of the number of times of detection of the fraudulent e-mail in the latest one week, one month, and one year with respect to the plurality of detected fraudulent e-mails.

In the example of FIG. 9, the display information 142 including the detection date and time of the fraudulent e-mail, the sender display information, the transmission source address, the subject, and the number of recipients is displayed on the screen of the management terminal 14 as information for each electronic mail that may be a fraudulent e-mail. Information for each electronic mail that may be a fraudulent e-mail is referred to as second information. In the display information 142, information for each electronic mail that may be a fraudulent e-mail is displayed in a list in descending order of the detection date and time of the fraudulent e-mail. According to the display information 142, it is possible to accurately grasp information including the detection date and time, the sender display information, the transmission source address, the subject, and the number of recipients for each fraudulent e-mail. According to the display information 142, it is possible to compare information including the detection date and time, the sender display information, the transmission source address, the subject, and the number of recipients with respect to a plurality of fraudulent e-mails. For example, the pieces of information may be sorted by clicking the detection date and time, the sender indication information, the transmission source address, the subject, and the number of recipients in the upper part of the display information 142. For example, the job of a person set as the sender may be displayed as information for each electronic mail that may be a fraudulent e-mail.

The display information displayed on the screen of the management terminal 14 may be sortable by the detection date and time of the fraudulent e-mail, the sender display information, the transmission source address, the subject, and the number of recipients. For example, the display information may be obtained by sorting information about fraudulent e-mails detected in a specific period. For example, the display information displayed on the screen of the management terminal 14 may is obtained by displaying information regarding the latest about 10 fraudulent e-mails. According to the example of FIG. 9, it is possible to refer to a combination of the transition of the number of times of detection of the fraudulent e-mail and the list information of electronic mails that may be fraudulent e-mails. For example, by confirming that the number of times of detection of the fraudulent e-mail in the latest one month is one and sorting by detection date and time within one month, it is possible to grasp what kind of fraudulent e-mails have been detected.

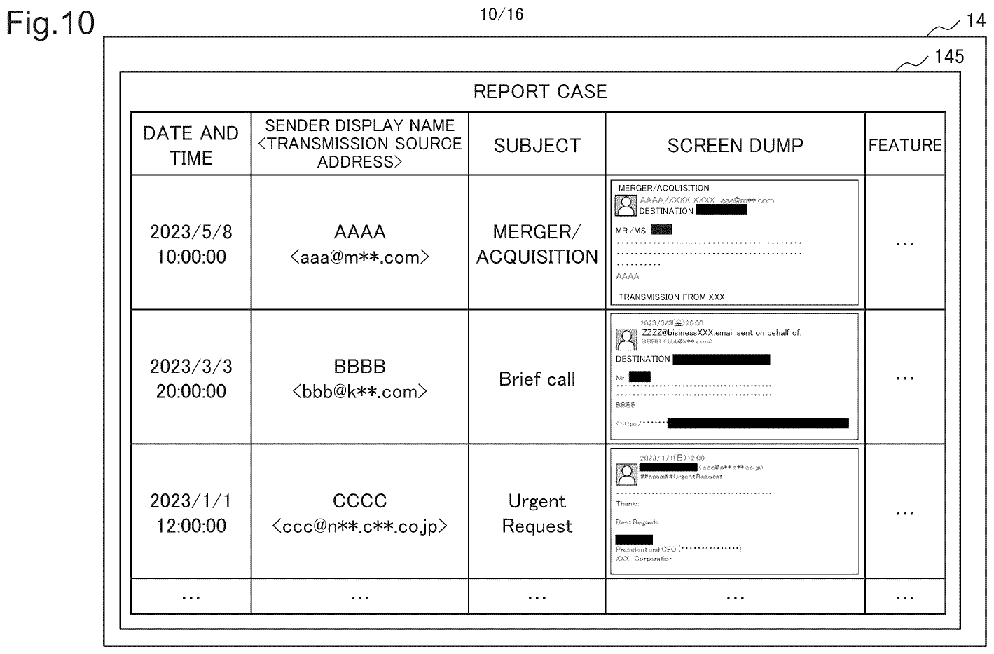

FIG. 10 is a conceptual diagram illustrating an example of the display information displayed on the screen of the management terminal. In the example of FIG. 10, display information 145 displayed in a list of report cases of the fraudulent e-mails is displayed on the screen of the management terminal 14. In FIG. 10, information such as a detected or reported date and time, a sender display name, a transmission source address, a subject, a screen dump, and a feature is displayed side by side for each report case of the fraudulent e-mail on the screen of the management terminal 14. Providing a screen dump of a fraudulent e-mail to the employee to raise attention to the fraudulent e-mail can reduce the risk of the employee following the instructions of the fraudulent e-mail. For example, the feature included in the header information or the body is described in the feature of the fraudulent e-mail. For example, the feature of the header information of the fraudulent e-mail includes information such as the name of an executive being described in the transmission source header of the electronic mail. For example, the features of the body of the fraudulent e-mail include a scheme of fraud by an attacker, a countermeasure when the fraudulent e-mail is received, and the like.

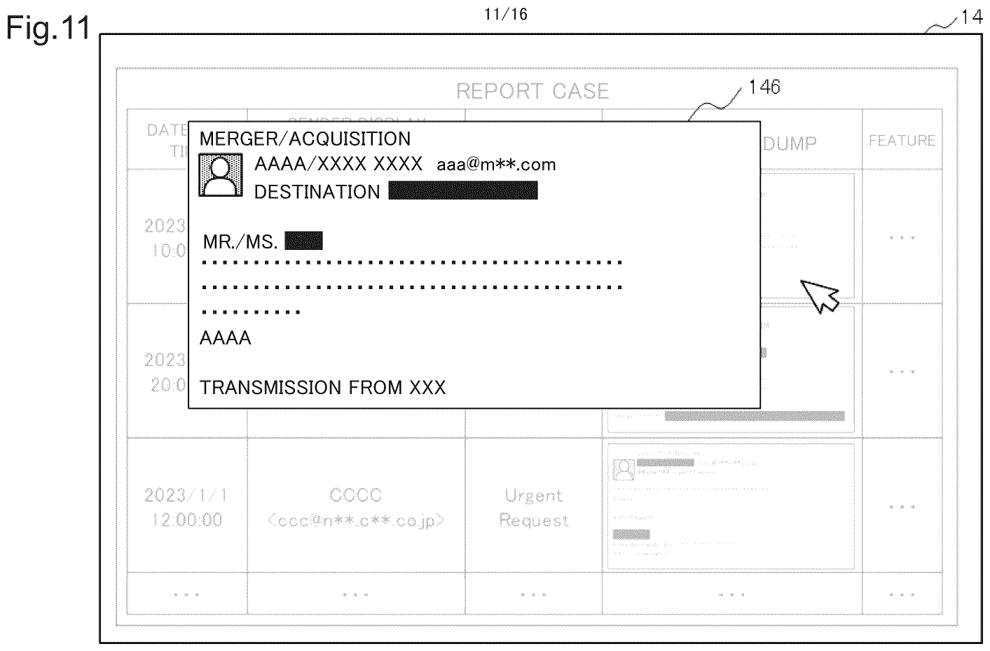

FIG. 11 is a conceptual diagram illustrating an example of screen transition of the display information displayed on the screen of the management terminal. In the display information 145 regarding the report case of FIG. 11, an enlarged image 146 of the screen dump is displayed according to the selection of the screen dump of the fraudulent e-mail. According to the example of FIG. 11, the content of the fraudulent e-mail can be easily confirmed in detail by the enlarged image 146 of the screen dump. In FIG. 11, a portion relevant to personal information such as a destination is filled in black and is hidden. For example, a process of blackening the destination or the like is manually performed. For example, the personal name extracted by the language analysis technique may be automatically painted black. For example, the enlarged image 146 may be enlarged and displayed with increased resolution. When the resolution of the enlarged image 146 is higher, it is easier to visually recognize the information included in the fraudulent e-mail.

The display examples of FIGS. 9 to 11 are merely examples, and do not limit the display information displayed by the detection system of the present example embodiment. The positional relationship and arrangement of the information included in the display information can be arbitrarily set as long as the information is displayed in a dashboard format. The display format of the display information may be changed according to the handling status of the fraudulent e-mail. For example, the information included in the display information may be displayed in different colors, sizes, or fonts according to the risk, urgency, or the like of the fraudulent e-mail. For example, the information included in the display information may be displayed in different colors, or sizes according to the risk, urgency, or the like of the fraudulent e-mail. The target department or person of the fraudulent e-mail may be displayed in a table format according to the analysis result of the destination information of the recipient set as the transmission destination of the fraudulent e-mail.

### (Operation)

Next, an operation of the detection system 10 of the present example embodiment will be described with reference to the drawings. Hereinafter, the detection device 11 and the control device 13 included in the detection system 10 will be individually described.

### [Detection Device]

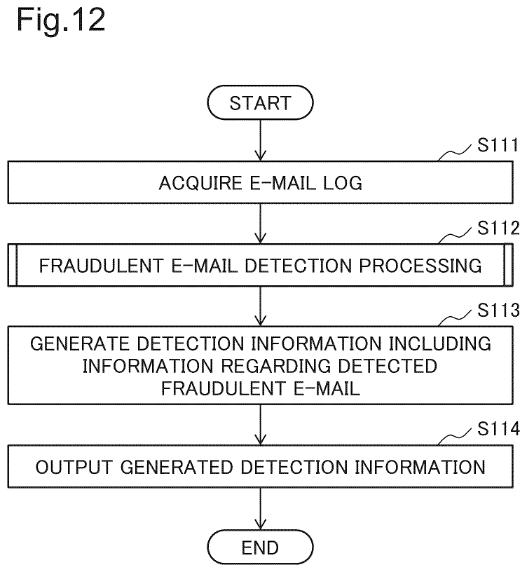

FIG. 12 is a flowchart for explaining an example of the operation of the detection device according to the present disclosure. In the description of the processing along the flowchart of FIG. 12, the components of the detection device 11 will be described as the operation subject. The operation subject of the processing along the flowchart of FIG. 12 may be the detection device 11.

In FIG. 12, first, the e-mail log acquisition unit 111 acquires an e-mail log from the e-mail log database 16 (step S111). For example, the e-mail log acquisition unit 111 acquires the e-mail log at a preset timing. The e-mail log acquisition unit 111 may acquire the e-mail log at a timing when the e-mail log is recorded in the e-mail log database 16.

Next, the detection unit 113 executes fraudulent e-mail detection processing (step S112). In the fraudulent e-mail detection processing, the detection unit 113 detects the fraudulent e-mail using the header information of the e-mail log. A detailed example of the fraudulent e-mail detection processing in step S112 will be described later.

Next, the detection information generation unit 115 generates detection information including information regarding the detected fraudulent e-mail (step S113). For example, the detection information includes header information of a fraudulent e-mail. The detection information may include a body or an attached file of the fraudulent e-mail.

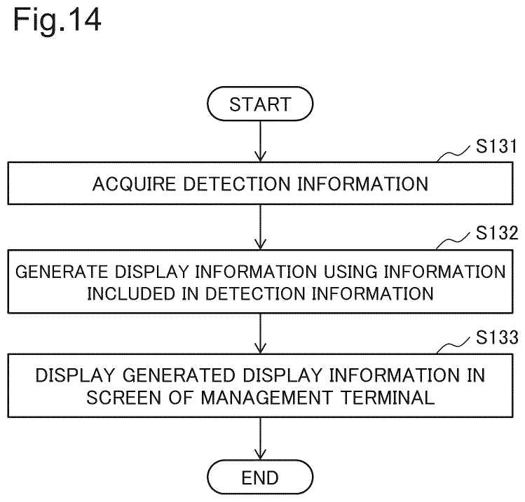

Next, the output unit 117 outputs the generated detection information to the control device 13 (step S114). The detection information output to the control device 13 is used for generating display information for grasping the information regarding the fraudulent e-mail. After step S114, the process proceeds to step S131 in FIG. 14.

### <Fraudulent E-Mail Detection Processing>

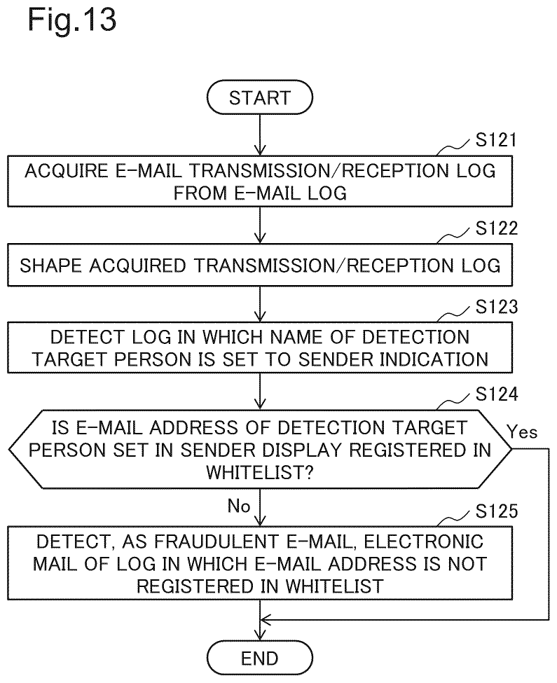

FIG. 13 is a flowchart for explaining an example of fraudulent e-mail detection processing (step S112 in FIG. 12) according to the present disclosure. In the description of the processing along the flowchart of FIG. 13, the components of the detection device 11 will be described as the operation subject. The operation subject of the processing along the flowchart of FIG. 13 may be the detection device 11. The flowchart of FIG. 13 is an example of the fraudulent e-mail detection processing, and does not limit the fraudulent e-mail detection processing.

In FIG. 13, first, the detection unit 113 acquires an e-mail transmission/reception log from an e-mail log (step S121).

Next, the detection unit 113 shapes the acquired transmission/reception log (step S122). The detection unit 113 shapes the transmission/reception log so that the sender indication included in the header information is easily detected.

Next, the detection unit 113 detects a log in which the name of the detection target person is set to the sender indication (step S123). For example, the detection target person is an executive or a manager of the management target company. The detection target person may be an executive or a manager of an affiliated company of the management target company.

Next, it is determined whether the e-mail address of the detection target person set to the sender indication is registered in the whitelist (step S124). In a case where the e-mail address of the detection target person set to the sender indication is not registered in the whitelist (No in step S124), the detection unit 113 detects the electronic mail of the log as a fraudulent e-mail. After step S125, the process proceeds to step S113 in FIG. 12. In a case where the e-mail address of the detection target person set to the sender indication is registered in the whitelist (Yes in step S124), the process according to the flowchart in FIG. 12 is ended.

### [Control Device]

FIG. 14 is a flowchart for explaining an example of the operation of the control device according to the present disclosure. In the description of the processing along the flowchart of FIG. 14, the components of the control device 13 will be described as the operation subject. The operation subject of the processing along the flowchart of FIG. 14 may be the control device 13.

In FIG. 14, first, the detection information acquisition unit 131 acquires detection information from the detection device 11 (step S131).

Next, the display information generation unit 135 generates display information including information regarding the fraudulent e-mail by using the information included in the detection information (step S132). The display information generation unit 135 generates display information indicating a detection status regarding the fraudulent e-mail in a dashboard format that can be easily grasped by the administrator.

Next, the display control unit 137 displays the generated display information on the screen of the management terminal 14 (step S133). On the screen of the management terminal 14, the detection status regarding the fraudulent e-mail is displayed in a display format that can be easily grasped by the administrator. The control device 13 may output the generated display information to the employee terminal 170 or an external system. The control device 13 may issue an instruction to the monitoring device 15 or the company-side e-mail server 17 to block the electronic mail transmitted from the transmission source address of the detected fraudulent e-mail.

As described above, the detection system of the present example embodiment includes the detection device and the control device. The detection device includes an e-mail log acquisition unit, a list storage unit, a detection unit, a detection information generation unit, and an output unit. The e-mail log acquisition unit acquires an e-mail log including header information of an electronic mail transmitted to an employee of the management target company. The list storage unit stores a whitelist in which authorized addresses of the management target company are listed. The detection unit detects a fraudulent e-mail according to a mismatch between the authorized address of the sender included in the header information and the transmission source address included in the header information. The detection information generation unit generates detection information including information regarding the detected fraudulent e-mail. The output unit outputs the generated detection information to the control device.

The control device includes a detection information acquisition unit, a storage unit, a display information generation unit, and a display control unit. The detection information acquisition unit acquires detection information including header information of an electronic mail transmitted to the management target company. The storage unit stores a template of display information to be presented to the administrator. The display information generation unit generates display information in which a plurality of pieces of information regarding an electronic mail, which may be a fraudulent e-mail, transmitted to the management target company is displayed side by side. The display control unit performs control to display the generated display information on the screen.

As described above, the control device according to the present example embodiment displays, on the screen, display information in which a plurality of pieces of information regarding an electronic mail, which may be a fraudulent e-mail, transmitted to an employee of the management target company is displayed side by side. Therefore, according to the present example embodiment, it is possible to grasp computer security such as a fraudulent e-mail.

In an aspect of the present example embodiment, the display information generation unit generates display information including information indicating transition of the number of times of detection of the fraudulent e-mail and a list of information of electronic mails that may be fraudulent e-mails. The display control unit displays, on the screen, display information including information indicating transition of the number of times of detection of the fraudulent e-mail and a list of information of electronic mails that may be fraudulent e-mails. According to the present aspect, it is possible to accurately grasp information regarding an electronic mail that may be a fraudulent e-mail displayed on the screen of the management terminal for each fraudulent e-mail.

In an aspect of the present example embodiment, the display information generation unit generates display information in which a sender display name and a transmission source address for each electronic mail that may be a fraudulent e-mail are included in a list of information of the electronic mails that may be fraudulent e-mails. The display control unit displays, on the screen, display information including a sender display name and a transmission source address for each electronic mail, which may be a fraudulent e-mail, in a list of information of electronic mails that may be fraudulent e-mails. According to the present aspect, it is possible to accurately grasp the sender display name and the transmission source address of the electronic mail that may be a fraudulent e-mail from the information for each electronic mail displayed on the screen of the management terminal.

In an aspect of the present example embodiment, the display information generation unit generates display information in which a subject for each electronic mail that may be a fraudulent e-mail is included in a list of information of the electronic mails that may be fraudulent e-mails. The display control unit displays, on the screen, display information in which a subject of each electronic mail that may be a fraudulent e-mail is included in a list of information of electronic mails that may be fraudulent e-mails. It is possible to accurately grasp a subject of an electronic mail that may be a fraudulent e-mail.

In an aspect of the present example embodiment, the display information generation unit generates display information including a list of report cases for each fraudulent e-mail in which a combination of at least two of a sender indication, a transmission source address, a subject, a screen dump, and a feature is included. The display control unit displays, on the screen, display information including a list of report cases for each fraudulent e-mail in which a combination of at least two of a sender indication, a transmission source address, a subject, a screen dump, and a feature is included. According to the present aspect, the feature included in the fraudulent e-mail can be accurately grasped by the report case displayed on the screen of the management terminal.

A control device according to an aspect of the present example embodiment includes a detection information acquisition unit that acquires detection information including header information of an electronic mail transmitted to a management target company. This aspect clarifies acquisition of detection information.

In an aspect of the present example embodiment, the detection device compares an authorized address of a sender registered in a whitelist in which authorized addresses of employees of a management target company are listed, with a transmission source address extracted from header information. In a case where the authorized address of the sender registered in the whitelist does not match the transmission source address extracted from the header information, the electronic mail in the e-mail log is detected as a fraudulent e-mail. According to the present aspect, the electronic mail transmitted from the sender of the transmission source address not registered in the whitelist can be detected as a fraudulent e-mail with reference to the whitelist.

### Second Example Embodiment

Next, a control device according to a second example embodiment will be described with reference to the drawings. The control device of the present example embodiment has a configuration in which the control device included in the detection system of the first example embodiment is simplified. The control device of the present example embodiment generates display information by using detection information output from the detection device included in the detection system of the first example embodiment.

### (Configuration)

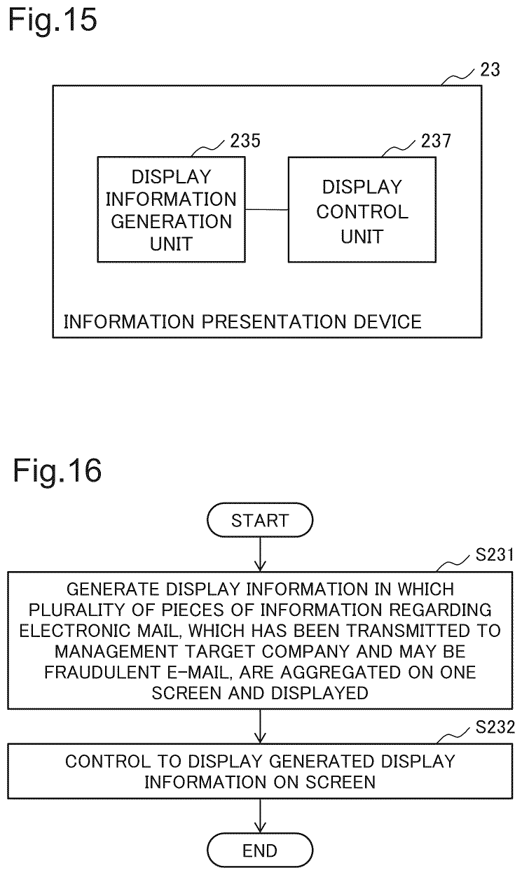

FIG. 15 is a block diagram illustrating an example of a configuration of a control device according to the present disclosure. A control device 23 includes a display information generation unit 235 and a display control unit 237. The display information generation unit 235 generates display information in which a plurality of pieces of information regarding an electronic mail, which may be a fraudulent e-mail, transmitted to the management target company is displayed side by side. The display control unit 237 performs control to display the generated display information on the screen.

### (Operation)

FIG. 16 is a flowchart for explaining an example of the operation of the control device according to the present disclosure. In the description of the processing along the flowchart of FIG. 16, the components of the control device 23 will be described as the operation subject. The operation subject of the processing along the flowchart of FIG. 16 may be the control device 23.

In FIG. 16, first, the display information generation unit 235 generates display information in which a plurality of pieces of information regarding an electronic mail, which may be a fraudulent e-mail, transmitted to the management target company is displayed side by side (step S231).

Next, the display control unit 237 performs control to display the generated display information on the screen (step S232).

The display information generation unit 235 can be achieved by using, for example, a function of the display information generation unit 135 in FIG. 8. The display control unit 237 can be achieved, for example, by using a function of the display control unit 137 in FIG. 8.

As described above, the control device according to the present example embodiment displays, on the screen, display information in which a plurality of pieces of information regarding an electronic mail, which may be a fraudulent e-mail, transmitted to an employee of the management target company is displayed side by side. Therefore, according to the present example embodiment, it is possible to grasp computer security such as a fraudulent e-mail.

### (Hardware)

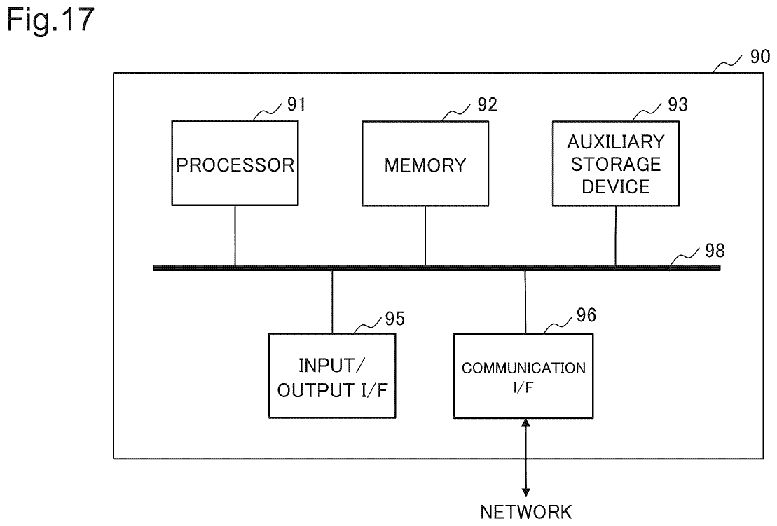

Next, a hardware configuration for executing control and processing in the present disclosure will be described with reference to the drawings. Here, an example of such a hardware configuration is an information processing device 90 (computer) in FIG. 17. The information processing device 90 in FIG. 17 is a configuration example for executing the control and processing in the present disclosure, and does not limit the scope of the present disclosure.

As illustrated in FIG. 17, the information processing device 90 includes a processor 91, a memory 92, an auxiliary storage device 93, an input/output interface 95, and a communication interface 96. In FIG. 17, the interface is abbreviated as an I/F. The processor 91, the memory 92, the auxiliary storage device 93, the input/output interface 95, and the communication interface 96 are data-communicably connected to each other via a bus 98. The processor 91, the memory 92, the auxiliary storage device 93, and the input/output interface 95 are connected to a network such as the Internet or an intranet via communication interface 96.

The processor 91 develops a program (instruction) stored in the auxiliary storage device 93 or the like in the memory 92. For example, the program is a software program for executing the control and processing in the present disclosure. The processor 91 executes the program developed in the memory 92. The processor 91 executes the control and processing in the present disclosure by executing the program.

The memory 92 is a storage device in which a program is developed. A program stored in the auxiliary storage device 93 or the like is developed in the memory 92 by the processor 91. The memory 92 is implemented by, for example, a volatile memory such as a dynamic random access memory (DRAM). A nonvolatile memory such as a magnetoresistive random access memory (MRAM) may be applied as the memory 92.

The auxiliary storage device 93 stores various data such as programs. For example, the auxiliary storage device 93 is implemented by a local disk such as a hard disk or a flash memory. Various data may be stored in the memory 92, and the auxiliary storage device 93 may be omitted.

The input/output interface 95 is an interface for connecting the information processing device 90 and a peripheral device. The communication interface 96 is an interface for connecting to an external system or device through a network such as the Internet or an intranet based on a standard or a specification. The input/output interface 95 and the communication interface 96 may be shared as an interface connected to an external device.

An input device such as a keyboard, a mouse, or a touch panel may be connected to the information processing device 90 as necessary. These input devices are used to input information and settings. When a touch panel is used as the input device, a screen having a touch panel function serves as an interface. The processor 91 and the input device are connected via the input/output interface 95.

The information processing device 90 may be provided with a display device for displaying information. In a case where a display device is provided, the information processing device 90 may include a control device (not illustrated) for controlling display of the display device. The display device may be connected to the information processing device 90 via the input/output interface 95.

The information processing device 90 may be provided with a drive device. The drive device mediates reading of data and a program stored in a recording medium and writing of a processing result of the information processing device 90 to the recording medium between the processor 91 and the recording medium (program recording medium). The information processing device 90 and the drive device are connected via an input/output interface 95.

The above is an example of the hardware configuration for enabling the control and processing in the present disclosure. The hardware configuration of FIG. 17 is an example of a hardware configuration for executing the control and processing in the present disclosure, and does not limit the scope of the present disclosure. A program for causing a computer to execute the control and processing in the present disclosure is also included in the scope of the present disclosure.

A program recording medium in which the program in the present example embodiment is also recorded is also included in the scope of the present invention. For example, the program recording medium is a computer-readable non-transitory recording medium. The recording medium can be achieved by, for example, an optical recording medium such as a compact disc (CD) or a digital versatile disc (DVD). The recording medium may be implemented by a semiconductor recording medium such as a universal serial bus (USB) memory or a secure digital (SD) card. The recording medium may be implemented by a magnetic recording medium such as a flexible disk, or another recording medium.

The components in the present disclosure may be arbitrarily combined. The components in the present disclosure may be implemented by software. The components in the present disclosure may be implemented by a circuit.

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

Some or all of the above example embodiments may be described as the following Supplementary Notes, but are not limited to the following.

### (Supplementary Note 1)

A control device including:
a display information generation unit that generates display information in which a plurality of pieces of information regarding an electronic mail that has been transmitted to a management target company and is likely to be a fraudulent e-mail are displayed side by side; and
a display control unit that performs control to display the generated display information on a screen.

### (Supplementary Note 2)

The control device according to Supplementary Note 1, in which
the display information includes:
information indicating transition of a number of times of detection of a fraudulent e-mail; and a list of information of electronic mails that are likely to be fraudulent e-mails.

### (Supplementary Note 3)

The control device according to Supplementary Note 2, in which
the display information includes
a sender display name and a transmission source address for each electronic mail, which is likely to be a fraudulent e-mail, in a list of information of electronic mails that are likely to be fraudulent e-mails.

### (Supplementary Note 4)

The control device according to Supplementary Note 3, in which
the display information includes
a subject for each electronic mail, which is likely to be a fraudulent e-mail, in a list of information of electronic mails that are likely to be fraudulent e-mails.

### (Supplementary Note 5)

The control device according to Supplementary Note 1, in which
the display information includes
a list of report cases for each fraudulent e-mail in which a combination of at least two of a sender indication, a transmission source address, a subject, a screen dump, and a feature is included.

### (Supplementary Note 6)

The control device according to Supplementary Note 1, including a detection information acquisition unit that acquires detection information including header information of an electronic mail transmitted to the management target company.

### (Supplementary Note 7)

The control device according to Supplementary Note 1, in which
the fraudulent e-mail is
an electronic mail in which an authorized address of a sender registered in a whitelist having listed authorized addresses of employees of the management target company does not match a transmission source address extracted from header information of an electronic mail transmitted to the management target company.

### (Supplementary Note 8)

A detection system including:
the control device according to any one of Supplementary Notes 1 to 7; and
a detection device that acquires an e-mail log including header information of an electronic mail transmitted to an employee of a management target company, detects a fraudulent e-mail according to a mismatch between an authorized address of a sender included in the header information and a transmission source address included in the header information, generates detection information including information regarding the detected fraudulent e-mail, and outputs the generated detection information to the control device.

### (Supplementary Note 9)

A control method for causing a computer to execute:
generating display information in which a plurality of pieces of information regarding an electronic mail that has been sent to a management target company and is likely to be a fraudulent e-mail are displayed side by side; and
performing control to display the generated display information on a screen.

### (Supplementary Note 10)

A program causing a computer to execute:
generating display information in which a plurality of pieces of information regarding an electronic mail that has been sent to a management target company and is likely to be a fraudulent e-mail are displayed side by side; and
performing control to display the generated display information on a screen.

Some or all of the configurations described in Supplementary Notes 2 to 8 dependent on Supplementary Note 1 described above can also depend on Supplementary Notes 9 and 10 in the same dependency relationship as the Supplementary Notes 2 to 8. Not only Supplementary Notes 1, 9, and 10 but also various pieces of hardware, software, and various recording medium for recording software, or a system can be similarly dependent on some or all of the configurations described as Supplementary Notes without departing from the above-described example embodiments.

1. A control device comprising:
a memory storing instructions; and
a processor connected to the memory and configured to execute the instructions to:
generate display information in which a plurality of pieces of information regarding an electronic mail that has been transmitted to a management target company and is likely to be a fraudulent e-mail are displayed side by side; and
perform control to display the generated display information on a screen.

2. The control device according to claim 1, wherein
the display information includes
information indicating transition of a number of times of detection of a fraudulent e-mail, and
a list of information of electronic mails that are likely to be fraudulent e-mails.

3. The control device according to claim 2, wherein
the display information includes
a sender display name and a transmission source address for each electronic mail, which is likely to be a fraudulent e-mail, in a list of information of electronic mails that are likely to be fraudulent e-mails.

4. The control device according to claim 3, wherein
the display information includes
a subject for each electronic mail, which is likely to be a fraudulent e-mail, in a list of information of electronic mails that are likely to be fraudulent e-mails.

5. The control device according to claim 1, wherein
the display information includes
a list of report cases for each fraudulent e-mail in which a combination of at least two of a sender indication, a transmission source address, a subject, a screen dump, and a feature is included.

6. The control device according to claim 1, wherein
the processor is configured to execute the instructions to
acquire detection information including header information of an electronic mail transmitted to the management target company.

7. The control device according to claim 1, wherein
the fraudulent e-mail is an electronic mail in which an authorized address of a sender registered in a whitelist having listed authorized addresses of employees of the management target company does not match a transmission source address extracted from header information of an electronic mail transmitted to the management target company.

8. A detection system comprising:
the control device according to claim 1; and
a detection device that comprises
a memory storing instructions; and
a processor connected to the memory and configured to execute the instructions to
acquire an e-mail log including header information of an electronic mail transmitted to an employee of a management target company,
detect a fraudulent e-mail according to a mismatch between an authorized address of a sender included in the header information and a transmission source address included in the header information,
generate detection information including information regarding the detected fraudulent e-mail, and
output the generated detection information to the control device.

9. A control method for causing a computer to execute:
generating display information in which a plurality of pieces of information regarding an electronic mail that has been sent to a management target company and is likely to be a fraudulent e-mail are displayed side by side; and
performing control to display the generated display information on a screen.

10. A non-transitory recording medium having stored therein a program causing a computer to execute:
generating display information in which a plurality of pieces of information regarding an electronic mail that has been sent to a management target company and is likely to be a fraudulent e-mail are displayed side by side; and
performing control to display the generated display information on a screen.
